(19) United States
(12) Patent Application Publication
(10) Pub. No.: US 2017/0192147 A1
(43) Pub. Date: Jul. 6, 2017

(54) DISPLAY APPARATUS

(71) Applicant: Samsung Display Co., Ltd., Yongin-Si (KR)

(72) Inventors: Juhwa HA, Asan-si (KR); Byungchan KIM, Yongin-si (KR); Hyun-jeong KIM, Hwaseong-si (KR)

(21) Appl. No.: 15/224,709

(22) Filed: Aug. 1, 2016

(30) Foreign Application Priority Data
Dec. 31, 2015 (KR) 10-2015-0190822

(51) Int. Cl. F21V 8/00

(52) U.S. Cl. CPC G02B 6/009; G02B 6/0046; G02B 6/0088; G02B 6/0031

(57) ABSTRACT

A display apparatus includes a display panel which displays an image with light, a light guide plate which provides the light to the display panel and a light source unit which generates the light and provides the light to the light guide plate. The light source unit includes a printed circuit board which includes a transparent material, supports the display panel thereon and defines a first surface which faces the light guide plate, a light source on the first surface of the printed circuit board, a resin layer which covers the light source and is disposed between the printed circuit board and the light guide plate, and an adhesive member disposed between the printed circuit board and the display panel. A thickness of the adhesive member is the same as a distance between the display panel and the printed circuit board.

This application claims priority to Korean Patent Application No. 10-2015-0190822, filed on Dec. 31, 2015, and all the benefits accruing therefrom under 35 U.S.C. §119, the content of which in its entirety is hereby incorporated by reference.

### BACKGROUND

(1) Field

The invention disclosed herein relates to a display apparatus.

(2) Description of the Related Art

Flat panel type display apparatuses include a liquid crystal display device (“LCD”), a plasma display device (“PDP”), a field emission display device (“FED”), a light emitting diode display device, an organic light emitting diode display device, and the like.

Among these flat panel type display apparatuses, the liquid crystal display device has secured a strong market due to advantages of advancement of mass production technology, relative ease driving, relatively low power consumption and thin thickness, and implementation of relatively high picture quality and large screen, and has expanded the field of application for flat panel type display apparatuses.

With the advancement of flat panel display technology, research and development to provide a display product having various designs according to consumer demands had been conducted.

### SUMMARY

One or more exemplary embodiment of the invention provides a display apparatus having a relatively slim design.

One or more exemplary embodiment of the invention also provides a display apparatus with improved display quality.

An exemplary embodiment of the invention provides a display apparatus including a display panel which displays an image with light, a light guide plate and a light source unit. The display panel includes or defines a display surface at which the image is displayed and a rear surface opposed to the display surface. The light guide plate is disposed under the display panel and provides the light to the display panel. The light source unit generates the light, provides the light to the light guide plate and is disposed at one side of the light guide plate. The light source unit may include a printed circuit board, a light source, a resin layer, and an adhesive member.

In an exemplary embodiment, the light guide plate may be a rectangular parallelepiped shape.

In an exemplary embodiment, the printed circuit board may include a transparent material, and may support the display panel thereon. The printed circuit board may define a first surface thereof facing the light guide plate. The transparent material may be glass. A thickness of the printed circuit board may be the same as a thickness of the light guide plate.

In an exemplary embodiment, the light source may be mounted on the first surface of the printed circuit board which faces the light guide plate.

In an exemplary embodiment, the resin layer may cover the light source on the first surface of the printed circuit board, and may be disposed between the printed circuit board and the light guide plate. The resin layer may include or be made of a transparent resin. The resin layer may have a refractive index that is less than or equal to a refractive index of the light guide plate. The refractive index of the resin layer may be in a range from about 1.45 to about 1.93.

In an exemplary embodiment, the adhesive member may be disposed between the printed circuit board and the display panel and fixes the printed circuit board and the display panel to each other. The thickness of the adhesive member may be the equal to a distance between the display panel and the printed circuit board. A top surface of the adhesive member may be in contact with the rear surface of the display panel, and a bottom surface of the adhesive member opposed to the top surface may be in contact with the printed circuit board and the resin layer.

In an exemplary embodiment, the thickness of the adhesive member may also be the same as a distance between the display panel and the light guide plate. The adhesive member may include a thermoplastic resin or a polyurethane resin.

In an exemplary embodiment, the printed circuit board may further define a second surface thereof opposing the first surface thereof. The light source unit may further include a reflection member. The reflection member may be disposed on the second surface of the printed circuit board opposing the first surface thereof. The reflection member may be a reflection tape or a thin coating film which includes a reflective material.

In an exemplary embodiment, the display apparatus may further include a bottom cover disposed under the light guide plate and the light source unit. The bottom cover may include a lower portion and a side portion.

In an exemplary embodiment, the lower portion may face the display panel such that the light guide plate and the light source unit are disposed between the lower portion and the display panel. The side portion may be connected to the lower portion, and may extend in a thickness direction of the light guide plate, the printed circuit board and the display panel.

In an exemplary embodiment, the lower portion and the side portion may each include a metallic material. In another exemplary embodiment, the lower portion and the side portion may include different materials from each other, and the side portion may be provided as a film.

In yet another exemplary embodiment of the invention, from the one side of the light guide plate at which the light source unit disposed, a thickness of the light guide plate may gradually decrease away from the light source unit. When viewed in a cross-section of the light guide plate parallel to a plane formed by a direction perpendicular to the first surface of the printed circuit board and a direction perpendicular to the display surface, the light guide plate may be a trapezoidal shape.

In one or more exemplary embodiment of the display apparatus according to the invention, as the printed circuit board supports the display panel thereon, separate supporting members such as a middle mold, a supporting frame and the like of a conventional display apparatus may be omitted. Thus, since the printed circuit board supports the display panel thereon to omit the conventional separate supporting members, one or more exemplary embodiment of the display apparatus according to the invention may be slimly manufactured to have an overall reduced cross-sectional thickness.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain principles of the invention. In the drawings:

FIG. 1 is a perspective view illustrating an exemplary embodiment of a display apparatus according to the invention;

FIG. 2 is an exploded view illustrating the display apparatus of FIG. 1 according to the invention;

FIG. 3 is a cross-sectional view of the display apparatus taken along line I-I′ of FIG. 1;

FIG. 4 is a cross-sectional view illustrating another exemplary embodiment of a display apparatus according to the invention;

FIG. 5 is a perspective view illustrating still another exemplary embodiment of a display apparatus according to the invention; and

FIG. 6 is a cross-sectional view of the display apparatus taken along line II-II′ of FIG. 5.

### DETAILED DESCRIPTION

The invention may be variously modified and embodied in various forms, and thus specific embodiments will be exemplified in the drawings and described in detail herein below. However, the invention is not limited to the specific disclosed forms, and should be construed to include all modifications, equivalents, or replacements included in the spirit and technical scope of the invention.

It should be understood that the terms “include”, “comprise”, “including,” “comprising,” “have” or “having” specify an existence of a property, a fixed number, a step, an operation, an element, a component or a combination thereof, but do not exclude the existence or addition of one or more other properties, fixed numbers, steps, operations, elements, components or combinations thereof. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items.

It will also be understood that when a layer, a film, a region, or a substrate is referred to as being “on” another one, it can be directly on the other one, or one or more intervening ones may also be present. Similarly, when a layer, a film, a region, or a substrate is referred to as being “under” another one, it can be directly under the other one, or one or more intervening ones may also be present. To the contrary, when a layer, a film, a region, or a substrate is referred to as being “directly on” or “directly under” another one, no intervening ones are present therebetween.

Like reference numerals in the drawings denote like elements. In the drawings, the dimensions of structures are exaggerated for clarity. Although terms like a first and a second are used to describe various elements, components, and/or sections in various embodiments of the invention, the elements, components, and/or sections are not limited thereto. These terms are used only to differentiate one element, component, or section from another one. For example, it will be apparent that a first element, a first component, or a first section described hereinafter may refer to a second element, a second component, or a second section within the scope of the invention. The terms of a singular form may include plural forms unless apparently referred to the contrary.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, example embodiments of the invention will be described in detail with reference to the accompanying drawings.

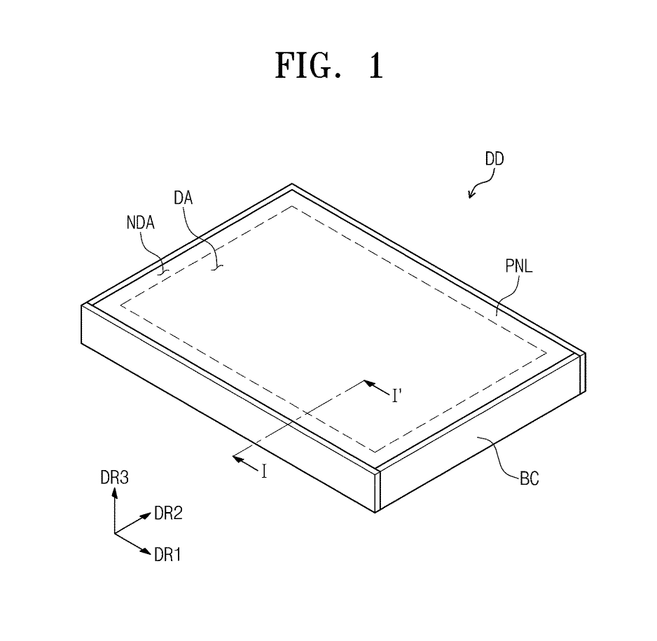

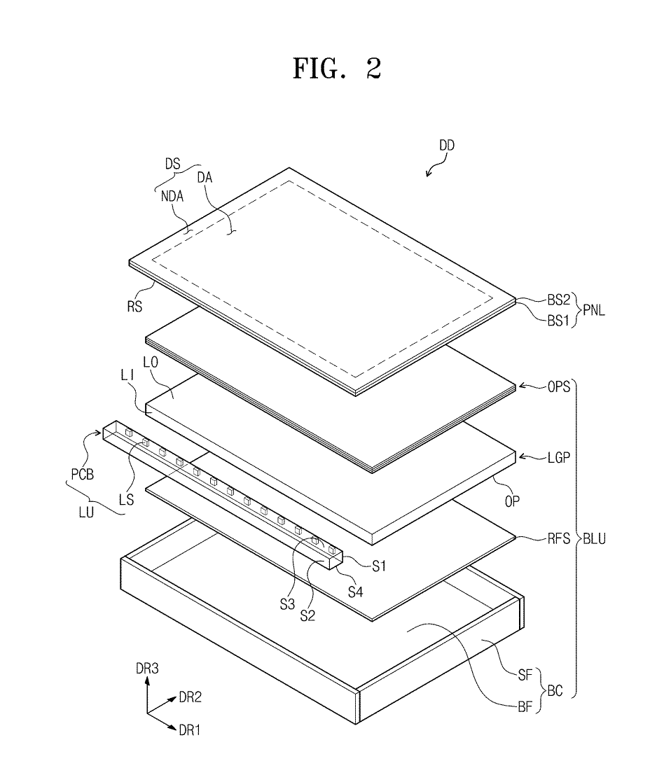

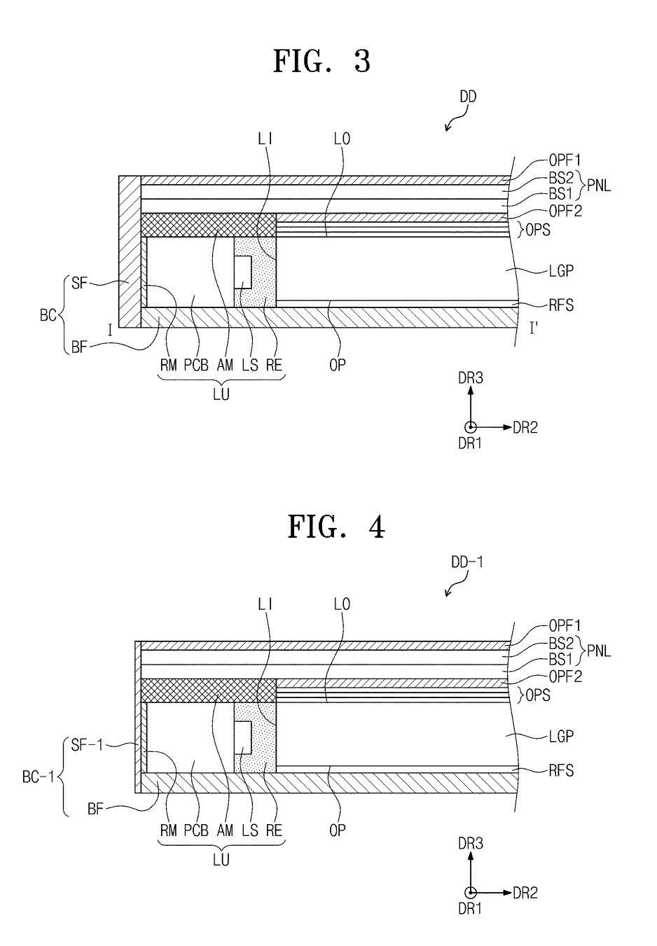

FIG. 1 is a perspective view illustrating an exemplary embodiment of a display apparatus according to the invention, FIG. 2 is an exploded view illustrating the display apparatus of FIG. 1 according to the invention, and FIG. 3 is a cross-sectional view of the display apparatus taken along line I-I′ of FIG. 1.

Referring to FIGS. 1 to 3, a display apparatus DD may include a display panel PNL and a backlight unit BLU. For convenience of explanation, an upper direction is described as a direction in which an image is displayed, and a lower direction is described as an opposite direction to the upper direction, in the display apparatus DD. However, the upper or lower direction is a relative concept, and may be converted to other directions.

The display panel PNL may display an image in the upper direction using light. The display panel PNL may be a passive display panel, and may be a liquid crystal display panel, an electrowetting display panel, an electrophoretic display panel, or a microelectromechanical system (“MEMS”) display panel. The liquid crystal display panel is exemplarily described in this exemplary embodiment of the invention.

The display panel PNL has a substantially quadrangular plate shape defined by two pairs of sides. In an exemplary embodiment, the display panel PNL has a substantially rectangular shape defined by a pair of relatively long sides defining a length thereof extending in a first direction DR1, and a pair of relatively short sides defining a length thereof extending in a second direction DR2 crossing the first direction DR1.

The display panel PNL may include or define a display surface DS in the upper direction and configured to display the image, and a rear surface RS in the lower direction and opposed to the display surface DS.

The display surface DS of the display panel PNL may be divided into a display area DA at which the image is displayed and a non display area NDA which surrounds the display area DA and at which the image is not displayed. The display area DA and the non display area NDA may define an entire of the display surface DS.

The display panel PNL may include a first base substrate BS1, a second base substrate BS2 facing the first base substrate BS1, and a liquid crystal layer (not illustrated) provided between the first and second base substrates BS1 and BS2.

According to an exemplary embodiment, the first base substrate BS1 may include a plurality of pixel electrodes (not illustrated) and a plurality of thin film transistors (not illustrated) which is electrically connected to the plurality of the pixel electrodes in one-to-one correspondence with each other, on a first substrate therein. Each thin film transistor is connected to each pixel electrode corresponding thereto, and may switch a driving signal provided to each pixel electrode.

The second base substrate BS2 may include a common electrode (not illustrated) forming an electric field together with the pixel electrodes to control the alignment of liquid crystals, on a second substrate therein. The display panel PNL provides the image in a third direction DR3, that is, the upper direction by driving the liquid crystal layer.

Although not illustrated, a driver chip configured to provide the driving signal, a tape carrier package on which the driver chip is mounted, and a printed circuit board electrically connected to the display panel PNL through the tape carrier package may be provided in the display panel PNL.

The backlight unit BLU is configured to provide light to the display panel PNL, and may be provided under the display panel PNL. The backlight unit BLU may include a light guide plate LGP, a light source unit LU, an optical sheet OPS, a reflection sheet RFS and a bottom cover BC.

The light guide plate LGP is configured to guide the light incident into the light guide plate LGP to the display panel PNL, and may be disposed under the display panel PNL. The light guide plate LGP may include or be made of polymethyl methacrylate (“PMMA”), methylstyrene (“MS”), polycarbonate (“PC”), glass, or the like.

The light guide plate LGP may include or define a light incident surface LI, a light output surface LO and an opposing surface OP. The light generated by and emitted from the light source unit LU may be incident into the light guide plate LGP through the light incident surface LI. In an exemplary embodiment, the light guide plate LGP may be provided in a rectangular parallelepiped shape corresponding to the shape of the display panel PNL.

When the light source unit LU is disposed to face at least any one of side surfaces of the light guide plate LGP among side surfaces which connect two widest surfaces of the light guide plate LGP, the at least one of the side surfaces may be defined as the light incident surface LI.

The light output surface LO may be one of the two widest surfaces of the light guide plate LGP. The light output surface LO may be a plane opposing the rear surface RS of the display panel PNL. The light incident into the light guide plate LGP through the light incident surface LI may be emitted in the third direction DR3 towards the display panel PNL through the light output surface LO.

The opposing surface OP is the other one of the two widest surfaces of the light guide plate LGP, and is opposed to the light output surface LO. The light incident into the light incident surface LI may be moved through an inside of the light guide plate LGP by being reflected between the light output surface LO and the opposing surface OP.

The light source unit LU is configured to provide the light, and may be disposed on at least one side of the light guide plate LGP. The light source unit LU may be disposed to be opposed to the light incident surface LI.

The light source unit LU may include a printed circuit board PCB, a light source LS, a resin layer RE, a reflection member RM and an adhesive member AM.

A wiring for supplying power to the light source LS and controlling the light source LS is disposed such as by printing on the printed circuit board PCB.

The printed circuit board PCB may include a light source control unit (not illustrated) connected to the light source LS. The light source control unit (not illustrated) may output a local dimming signal by analyzing an image displayed on the display panel PNL, and may control brightness of the light source LS in response to the local dimming signal. The light source control unit (not illustrated) may be provided mounted on a separate printed circuit board, and a location thereof is not particularly limited.

In FIG. 2, the printed circuit board PCB is illustrated to define a length thereof extended in the first direction DR1 along one relatively long side of the display panel PNL. The printed circuit board PCB may include or define a first surface S1 facing the light incident surface LI, a second surface S2 opposed to the first surface S1, and connecting surfaces connecting the first surface S1 and the second surface S2 to each other. The connecting surfaces may be divided into a third (upper) surface S3 facing the rear surface RS of the display panel PNL, and a fourth (lower) surface S4 opposed to the third surface S3. End surfaces of the printed circuit board PCB may connect each of the first to fourth surfaces S1 to S4 to each other.

The printed circuit board PCB may include or be made of a transparent material and thus be provided in a transparent state. In an exemplary embodiment, the transparent material may be glass. Since the printed circuit board PCB is provided in a transparent state, visibility of the printed circuit board PCB outside the display apparatus DD when the display surface DS is viewed from the above of the display panel PNL may be reduced or effectively prevented.

The printed circuit board PCB may support the display panel PNL thereon. The printed circuit board PCB may be disposed to overlap the non display area NDA of the display panel PNL in a top plan view (e.g., when the display surface DS is viewed from the above of the display panel PNL). The printed circuit board PCB may fix the location of the display panel PNL relative to other components of the display apparatus DD. In an exemplary embodiment, a cross-sectional thickness of the printed circuit board PCB in the third direction DR3 may be substantially the same as a cross-sectional thickness of the light guide plate LGP in the third direction DR3.

The light source LS may be mounted on the first surface S1 of the printed circuit board PCB. The light source LS may be provided in plurality on the printed circuit board PCB or within the light source unit LU. In FIG. 2, the light sources LS are exemplarily illustrated to be arranged side by side in the first direction DR1 spaced a predetermined distance from each other. The light generated by and emitted from the light source LS may be incident into the light guide plate LGP. The light source LS may employ various light sources such as a dot light source, line light source or the like, but the type thereof is not limited thereto. In an exemplary embodiment, the light source LS is exemplarily described to employ a light emitting diode (“LED”) as the dot light source. The light source LS may be provided with an LED, or a plurality of LED groups.

The resin layer RE may be disposed between the printed circuit board PCB and the light guide plate LGP. The resin layer RE may cover the light source LS and the first surface S1 of the printed circuit board PCB. The resin layer RE may fill a space defined between the printed circuit board PCB and the light incident surface LI of the light guide plate LGP.

The resin layer RE may include or be made of a transparent resin such as an acrylic resin, a silicon resin or the like. The resin layer RE may have a refractive index that is less than or equal to a refractive index of the light guide plate LGP. In an exemplary embodiment, the refractive index of the resin layer RE may be in a range from about 1.45 to about 1.93.

As the resin layer RE is disposed between the printed circuit board PCB and the light guide plate LGP, leakage of the light emitted from the light source LS and through the space between the printed circuit board PCB and the light guide plate LGP may be reduced or effectively prevented. Thus, efficiency of the light that is generated by the light source LS and incident into the light guide plate LGP may be improved.

As illustrated in FIG. 3, the reflection member RM may be disposed on the second surface S2 of the printed circuit board PCB. The reflection member RM may reduce or effectively prevent leakage of the light emitted from the light source LS to the outside the backlight unit BLU through the printed circuit board PCB. The reflection member RM may be a reflective tape including a light reflective material and an adhesive material. The reflection member RM may be a thin coating film in which a light reflective material is coated on the second surface S2 of the printed circuit board PCB.

The adhesive member AM may be disposed between the printed circuit board PCB and the display panel PNL. The top surface of the adhesive member AM may be in contact with a portion of the rear surface RS of the display panel PNL, and the bottom surface of the adhesive member AM opposed to the top surface may be in contact with the third surface S3 of the printed circuit board PCB and the top surface of the resin layer RE. In an exemplary embodiment, as the surface of the printed circuit board PCB is made of or defined by relatively smooth glass, the adhesive member AM may be more firmly adhered to the printed circuit board PCB. Thus, the adhesive member AM may more firmly fix the printed circuit board PCB and the display panel PNL to each other.

A cross-sectional thickness of the adhesive member AM in the third direction DR3 may be the same as a spacing distance defined in the third direction DR3 between the display panel PNL and the printed circuit board PCB. A maximum cross-sectional thickness of the adhesive member AM in the third direction DR3 may be the same as a minimum spacing distance defined in the third direction DR3 between the display panel PNL and the printed circuit board PCB. Also, the cross-sectional thickness of the adhesive member AM may be substantially the same as a distance between the display panel PNL and the light guide plate LGP in the third direction DR3. The adhesive member AM may include a thermoplastic resin or a polyurethane resin.

The optical sheet OPS is disposed between the display panel PNL and the light guide plate LGP. The optical sheet OPS controls the light emitted from the light source LS. The optical sheet OPS collectively includes a plurality of individual sheets such as a diffusion sheet, a prism sheet and a protective sheet, which are sequentially stacked on the light guide plate LGP.

The diffusion sheet diffuses the light. The prism sheet serves to concentrate the light diffused by the diffusion sheet in a direction perpendicular to the plane of the display panel PNL provided thereabove. Most of the light passing through the prism sheet is perpendicularly incident into the display panel PNL. The protection sheet may be disposed on the prism sheet. The protection sheet may protect the prism sheet from an external impact. In an exemplary embodiment, the optical sheet OPS is exemplarily illustrated to include one of each of the diffusion sheet, the prism sheet and the protection sheet, but is not limited thereto. In another exemplary embodiment, for example, the optical sheet OPS may be used such that at least any one of the diffusion sheet, the prism sheet or the protection sheet is laminated in plurality, and one or more sheets may also be omitted, if necessary. Also, the diffusion sheet, the prism sheet and the protection sheet may be laminated in a different order.

The reflection sheet RFS may be disposed between the light guide plate LGP and the bottom cover BC. The reflection sheet RFS may include a light reflective material such as polyethylene terephthalate (“PET”), aluminum (Al), or the like. The reflection sheet RFS may serve to reflect light that fails to be emitted through the light output surface LO of the light guide plate LGP and leaks to the reflection sheet RFS through the opposing surface OP of the light guide plate LGP such that the light is incident back into the light guide plate LGP. Since the reflection sheet RFS is provided, a loss of the light provided to the display panel PNL may be reduced.

The bottom cover BC is provided under the light guide plate LGP, the light source unit LU, the optical sheet OPS and the reflection sheet RFS, and may support and/or house the light guide plate LGP, the light source unit LU, the optical sheet OPS and the reflection sheet RFS therein.

The bottom cover BC may include a lower portion BF and a side portion SF. The lower portion BF may be disposed to face the display panel PNL with the light guide plate LGP, the light source unit LU, the optical sheet OPS and the reflection sheet RFS in-between. The lower portion BF may include a metallic material.

The side portion SF is connected to the lower portion BF, and may extend in the third direction DR3. The side portion SF may be extended from outer edges of the lower portion BF. The side portion SF may be integrated with the lower portion BF, or may also be separably provided in an assembled state with the lower portion BF. As being integrated, one of the lower portion BF and the side portion SF may extend to define the other of the lower portion BF and the side portion SF. In an exemplary embodiment, the side SF may include the metallic material as the lower portion BF, and may have a relatively rigid material property.

Referring to FIG. 3, the display apparatus DD may further include a first optical film OPF1 provided on the display surface DS of the display panel PNL, and a second optical film OPF2 provided on the rear surface RS of the display panel PNL. The first optical film OPF1 may overlap at least the display area DA. The second optical film OPF2 may be attached to a remaining portion of the rear surface RS of the display panel PNL. In an exemplary embodiment, the first and second optical films OPF1 and OPF2 may be, for example, polarizing films.

In one or more exemplary embodiment of the display apparatus DD according to the invention, as the printed circuit board PCB supports the display panel PNL thereon, separate supporting members such as a middle mold, a supporting frame and the like of a conventional display apparatus may be omitted. Thus, since the printed circuit board PCB supports the display panel PNL thereon to omit the conventional separate supporting members, one or more exemplary embodiment of the display apparatus DD according to the invention may be slimly manufactured to have an overall reduced cross-sectional thickness.

Hereinafter, another exemplary embodiment of a display apparatus DD-1 according to the invention will be described with reference to accompanying drawings. For convenience of explanation, the display apparatus DD-1 will be described centered on different components from those of the foregoing exemplary embodiment, and components that are not described will be appreciated as being the same as those of the foregoing exemplary embodiment.

FIG. 4 is a cross-sectional view illustrating another exemplary embodiment of a display apparatus according to the invention. Hereinafter, the display apparatus DD-1 including a bottom cover BC-1 that is different from that of the foregoing exemplary embodiment will be described with reference to FIG. 4.

As illustrated in FIG. 4, in the display apparatus DD-1, the bottom cover BC-1 may include a lower portion BF and a side portion SF-1.

The lower portion BF may be disposed to face the display panel PNL such that a light guide plate LGP, a light source unit LU, an optical sheet OPS and a reflection sheet RFS are disposed between the lower portion BF and the display panel PNL. The lower portion BF may include a metallic material.

The side portion SF-1 is fixed to the lower portion BF, and may extend in a third direction DR3. The side portion SF-1 may be provided as a film, for example, an adhesive tape, a film printed with a colored material, or the like. That is, the side portion SF-1 of the display apparatus DD-1 may include a material different from that of the lower portion BF. Also, the film form of the side portion SF-1 of the display apparatus DD-1 may provide a reduced dimension of the display apparatus DD-1 in the first and second directions DR1 and DR2 to reduce an overall planar size of the display apparatus DD-1 in the plane thereof. The side portion SF-1 may be disposed at one or more sides of the display apparatus DD-1.

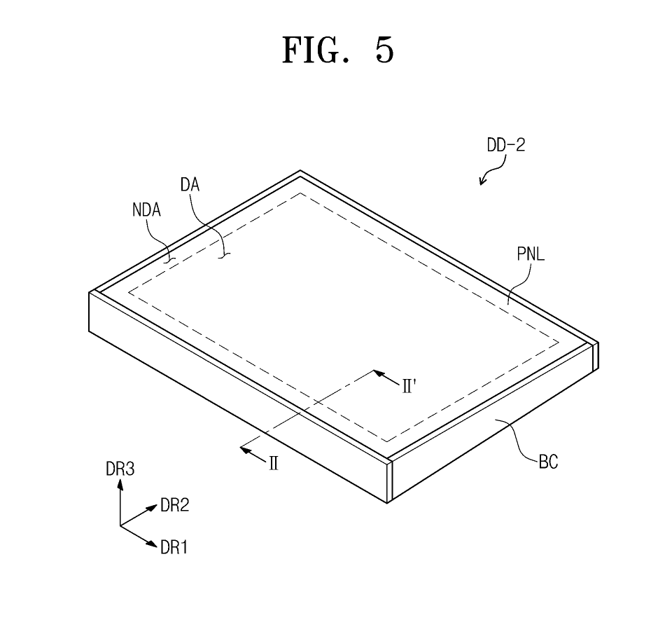

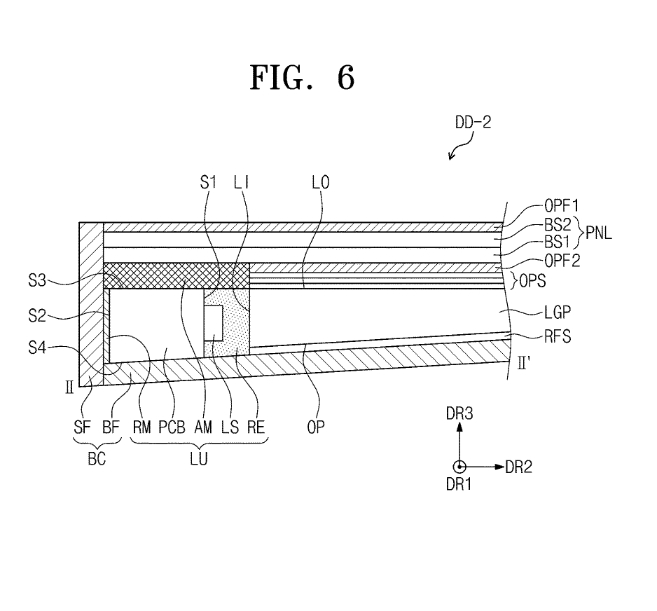

FIG. 5 is a perspective view illustrating still another exemplary embodiment of a display apparatus according to the invention, and FIG. 6 is a cross-sectional view of the display apparatus taken along line II-IF of FIG. 5.

Referring to FIGS. 5 and 6, a display apparatus DD-2 may be provided to have different overall cross-sectional thicknesses at respective locations thereof. The display apparatus DD-2 may include a display panel PNL and a backlight unit BLU. The backlight unit BLU may include a light guide plate LGP, a light source unit LU, an optical sheet OPS, a reflection sheet RFS and a bottom cover BC.

An overall cross-sectional thickness of the light guide plate LGP may gradually decrease in a direction away from the light source unit LU in the second direction DR2. When viewed in a cross-section of the light guide plate LPG parallel to a plane formed by the second direction DR2 and the third direction DR3 in FIG. 6, the cross-sectional shape may be provided in a trapezoidal shape.

In FIG. 6, a light incident surface LI and a light output surface LO of the light guide plate LGP are exemplarily illustrated to form an angle of 90°. Thus, an opposing surface OP may be provided at an oblique angle relative to the light incident surface LI, but not limited thereto. In still another exemplary embodiment, the light output surface LO and the opposing surface OP may also each be provided at oblique angles relative to the light incident surface LI to be disposed gradually closer to each other in the direction away from the light source unit LU in the second direction DR2.

The bottom cover BC may include a lower portion BF facing the opposing surface OP, and a side portion SF connected to the lower portion BF. The lower portion BF may be provided in a slanting (e.g., inclined) angle relative to the side portion SF to be parallel with the opposing surface OP of the light guide plate LGP.

The light source unit LU may include a printed circuit board PCB, a light source LS, a resin layer RE, a reflection member RM, and an adhesive member AM.

The printed circuit board PCB may include a first surface S1 facing the light incident surface LI, a second surface S2 opposed to the first surface S1, and connection surfaces that connect the first surface S1 and the second surface S2 to each other. The connection surfaces may be divided into a third surface S3 facing the rear surface RS of the display panel PNL, and a fourth surface S4 opposed to the third surface S3 and facing the lower portion BF. The fourth surface S4 may be provided at an oblique angle relative to the second surface S2 and extend along the shape or profile of the lower portion BF.

When viewed in a cross-section of the printed circuit board PCB parallel to the plane formed by the second and third directions DR2 and DR3, the cross-section of the printed circuit board PCB may be a trapezoidal shape.

In one or more exemplary embodiment of the display apparatus DD-2 according to the invention as the printed circuit board PCB supports the display panel PNL thereon, separate supporting members such as a middle mold, a supporting frame and the like of a conventional display apparatus may be omitted and an overall thickness of the display apparatus DD-2 may gradually decrease in a direction away from the light source unit LU. Thus, since the printed circuit board PCB supports the display panel PNL thereon to omit the conventional separate supporting members, one or more exemplary embodiment of the display apparatus DD-2 may be slimly manufactured to have an overall reduced cross-sectional thickness.

One or more exemplary embodiment of a display apparatus according to the invention may have a relatively slim design. Also, one or more exemplary embodiment of the display apparatus according to the invention may provide an image with improved display quality since the light that is generated by the light source and incident into the light guide plate may be improved.

While this disclosure has been particularly shown and described with reference to exemplary embodiments thereof, it will be understood by those skilled in the art that various changes in form and details may be made therein without departing from the spirit and scope of the invention as defined by the appended claims.

Hence, the technical scope of the invention is not limited to the exemplary embodiments and applications disclosed herein, but shall be determined by the appended claims.

What is claimed is:

1. A display apparatus comprising:
a display panel which displays an image with light and defines a display surface thereof at which the image is displayed and a rear surface thereof opposed to the display surface;
a light guide plate which is disposed under the display panel and provides the light to the display panel; and
a light source unit which generates the light and provides the light to the light guide plate, the light source unit disposed at one side of the light guide plate;
wherein the light source unit comprises:
a printed circuit board which comprises a transparent material and supports the display panel thereon, the printed circuit board defining a first surface thereof facing the light guide plate;
a light source on the first surface of the printed circuit board which faces the light guide plate;
a resin layer which is disposed between the printed circuit board and the light guide plate and covers the light source on the first surface of the printed circuit board; and
an adhesive member which is disposed between the printed circuit board and the display panel and fixes the printed circuit board and the display panel to each other,
wherein in a thickness direction of the adhesive member, a thickness of the adhesive member is the same as a distance between the display panel and the printed circuit board.

2. The display apparatus of claim 1, wherein the transparent material of the printed circuit board is glass.

3. The display apparatus of claim 2, wherein the resin layer which is disposed between the printed circuit board and the light guide plate and covers the light source on the first surface of the printed circuit board comprises a transparent resin.

4. The display apparatus of claim 3, wherein the resin layer which is disposed between the printed circuit board and the light guide plate and covers the light source on the first surface of the printed circuit board has a refractive index that is less than or equal to a refractive index of the light guide plate.

5. The display apparatus of claim 4, wherein the refractive index of the resin layer is in a range from about 1.45 to about 1.93.

6. The display apparatus of claim 2, wherein
the printed circuit board further defines a second surface thereof opposing the first surface thereof, and
the light source unit further comprises a reflection member disposed on the second surface of the printed circuit board opposing the first surface thereof.

7. The display apparatus of claim 6, wherein the reflection member which is disposed on the second surface of the printed circuit board opposing the first surface thereof is a reflection tape or a thin coating film including a reflective material.

8. The display apparatus of claim 2, wherein for the adhesive member disposed between the printed circuit board and the display panel,
a top surface of the adhesive member is in contact with the rear surface of the display panel, and
a bottom surface of the adhesive member opposed to the top surface thereof is in contact with the printed circuit board and the resin layer.

9. The display apparatus of claim 8, wherein in the thickness direction of the adhesive member disposed between the printed circuit board and the display panel, the thickness of the adhesive member is the same as a distance between the display panel and the light guide plate.

10. The display apparatus of claim 9, wherein the adhesive member disposed between the printed circuit board and the display panel comprises a thermoplastic resin or a polyurethane resin.

11. The display apparatus of claim 9, wherein in the thickness direction of the adhesive member disposed between the printed circuit board and the display panel, a thickness of the printed circuit board is the same as a thickness of the light guide plate.

12. The display apparatus of claim 11, wherein the light guide plate has a rectangular parallelepiped shape.

13. The display apparatus of claim 9, wherein from the one side of the light guide plate at which the light source unit disposed, a thickness of the light guide plate gradually decreases in a direction away from the light source unit.

14. The display apparatus of claim 13, wherein when viewed in a cross-section of the light guide plate parallel to a plane formed by a direction perpendicular to the first surface of the printed circuit board and a direction perpendicular to the display surface, the light guide plate has a trapezoidal shape.

15. The display apparatus of claim 1, further comprising a bottom cover disposed under the light guide plate and the light source unit,
wherein the bottom cover comprises:
a lower portion facing the display panel to dispose the light guide plate and the light source unit between the lower portion and the display panel; and
a side portion connected to the lower portion and extending in a thickness direction of the light guide plate, the printed circuit board and the display panel.

16. The display apparatus of the claim 15, wherein the lower portion and the side portion of the bottom cover each comprises a metallic material.

17. The display apparatus of claim 15, wherein the lower portion and the side portion of the bottom cover comprises different materials from each other, and the side portion is provided as a film.

18. The display apparatus of claim 17, wherein the side portion of the bottom cover is defined as an adhesive tape film or a film including a colored material.

19. A display apparatus comprising:
a display panel which displays an image with light and defines a display surface thereof at which the image is displayed and a rear surface thereof opposed to the display surface;
a light guide plate which is disposed under the display panel and provides the light to the display panel; and
a light source unit which generates the light and provides the light to the light guide plate, the light source unit disposed at one side of the light guide plate,
wherein the light source unit comprises:
a printed circuit board which comprises a transparent material and supports the display panel thereon, the printed circuit board defining a first surface thereof facing the light guide plate;
a light source on the first surface of the printed circuit board which faces the light guide plate;
a resin layer which is disposed between the printed circuit board and the light guide plate and covers the light source on the first surface of the printed circuit board; and
an adhesive member which is disposed between the printed circuit board and the display panel and fixes the printed circuit board to the display panel,
wherein in a thickness direction of the adhesive member disposed between the printed circuit board and the display panel, a thickness of the adhesive member is the same as a distance between the display panel and the light guide plate.

20. The display apparatus of claim 19, wherein in the thickness direction of the adhesive member disposed between the printed circuit board and the display panel, the thickness of the adhesive member is the same as a distance between the display panel and the printed circuit board.
